(19) United States
(12) Patent Application Publication
(10) Pub. No.: US 2016/0290744 A1
(43) Pub. Date: Oct. 6, 2016

(54) CLAD MATERIAL, METHOD OF MANUFACTURING PIPE, PIPE, AND HEAT EXCHANGER USING PIPE

(71) Applicant: KEIHIN THERMAL TECHNOLOGY CORPORATION, Oyama-shi (JP)

(72) Inventors: Takashi TERADA, Oyama-shi (JP); Kazuyuki TAKAHASHI, Oyama-shi (JP); Yohei IKAWA, Oyama-shi (JP)

(73) Assignee: KEIHIN THERMAL TECHNOLOGY CORPORATION, Oyama-shi (JP)

(21) Appl. No.: 15/169,602

(22) Filed: May 31, 2016

(30) Foreign Application Priority Data
Jun. 5, 2015 (JP) 2015-114782

(51) Int. Cl. F28F 21/08; C22C 21/10; F28F 1/12; B32B 15/01; F28D 7/00; C22C 21/02; C22C 21/00

(52) U.S. Cl. CPC F28F 21/084; C22C 21/02; C22C 21/10; C22C 21/00; B32B 15/016; F28D 7/0066; F28F 1/12; B32B 2597/00

(57) ABSTRACT

A clad material is composed of a core material, a first skin material covering one side of the core material, a second skin material covering the other side of the core material, and an intermediate material interposed between the core material and the first skin material. The core material is made of an Al alloy containing Cu (0.3 to 0.5 mass %), Mn (0.6 to 1.0 mass %), Ti (0.05 to 0.15 mass %). The first skin material is made of an Al alloy containing Si (7.9 to 9.5 mass %) and Fe (0.1 to 0.3 mass %). The second skin material is made of an Al alloy containing Si (4.5 to 5.5 mass %) and Cu (0.5 to 0.7 mass %). The intermediate material is made of an Al alloy containing Mn (0.2 to 0.4 mass %) and Zn (0.2 to 0.4 mass %).

### BACKGROUND OF THE INVENTION

The present invention relates to a clad material which is composed of a core material, a first skin material covering one side of the core material, and a second skin material covering the other side of the core material and which is used for manufacturing, for example, header tanks for a heat exchanger. The present invention also relates to a method of manufacturing a pipe from the clad material, the pipe, and to a heat exchanger which includes the pipe.

In this specification and claims, the term “aluminum” encompasses aluminum alloys in addition to pure aluminum. Also, materials represented by chemical symbols represent pure materials, and the term “Al alloy” means an aluminum alloy.

In this specification, the term “spontaneous potential” of a material refers to the electrode potential of the material within an acidic (pH: 3) aqueous solution of 5% NaCl with respect to a saturated calomel electrode (S.C.E.), which serves as a reference electrode.

There has been known a clad material for heat exchangers which is composed of a core material, a first skin material covering one side of the core material and forming the wall surface of a refrigerant passage, and a second skin material covering the other side of the core material and forming an outer surface which comes into contact with the atmosphere (see Japanese Patent Application Laid-Open (kokai) No. 2008-240084). Such a clad material is used for manufacturing components for heat exchangers. In the known clad material, the core material is made of an Al alloy which contains Si in an amount of 0.3 to 1.5 mass %, Mn in an amount of 0.5 to 1.8 mass %, Mg in an amount of 1.5 mass % or less, Cu in an amount of 1.0 mass % or less, and Ti in an amount of 0.1 to 0.35 mass %, the balance being Al and unavoidable impurities. The first skin material is made of an Al alloy which contains Si in an amount of 1.5 mass % or less, Mn in an amount of 1.8 mass % or less, and Cu in an amount of 1.0 mass % or less, the balance being Al and unavoidable impurities. The second skin material is made of an Al alloy which contains Si in an amount of 1.5 mass % or less, Mn in an amount of 1.8 mass % or less, and Zn in an amount of 2.5 to 7.0 mass %, the balance being Al and unavoidable impurities. The Cu content of the first skin material is equal to or higher than the Cu content of the core material.

In the clad material disclosed in the above-mentioned publication, the spontaneous potential of a layer (the second skin material) which forms an outer surface of an heat exchanger exposed to an corrosive environment is rendered less noble than the core material so that the layer serves as a sacrificial anode layer for the core material; and the spontaneous potential of a layer (the first skin material) which forms an inner surface of the heat exchanger which comes into contact with refrigerant is rendered noble with respect to the core material, whereby a sacrificial corrosion protection effect is attained at positions deeper than the center of the core material in the thickness direction thereof.

Incidentally, a heat exchanger having the following structure has been widely known and used as a condenser of an air conditioner for a vehicle. The heat exchanger includes a plurality of heat exchange tubes disposed at predetermined intervals such that they have the same longitudinal direction; fins each disposed between adjacent heat exchange tubes; a plurality of header tanks disposed on opposite sides of the heat exchange tubes with respect to the longitudinal direction thereof such that the longitudinal direction of the header thanks coincides with the direction in which the heat exchange tubes are juxtaposed; and a heat exchanger component formed of a bare material and fixed to at least one of the header tanks, wherein each header tank is composed of a pipe having openings at opposite ends thereof and closing members for closing the openings at the opposite ends of the pipe.

The pipe of each header tank of the above-described heat exchanger is manufactured, for example, by the following method.

First, there is prepared a clad material composed of a core material, a first skin material made of an Al alloy brazing material and covering one side of the core material, and a second skin material made of an Al alloy brazing material and covering the other side of the core material. A first slanting surface is formed on the upper surface of one side edge portion of the clad material such that the first slanting surface inclines downward toward the end, and the first slanting surface is covered with the first skin material. A first flat surface is formed between the lower end of the first slanting surface and the lower surface such that the first flat surface forms an obtuse angle in relation to the first slanting surface, and a right angle in relation to the lower surface. A second slanting surface is formed on the lower surface of the other side edge portion of the clad material such that the second slanting surface inclines upward toward the end, and the second skin material is present on the second slanting surface. A second flat surface is formed between the lower end of the second slanting surface and the lower surface such that the second flat surface forms an obtuse angle in relation to the second slanting surface, and a right angle in relation to the lower surface. Subsequently, the clad material is formed into a tubular shape such that the first surface covered with the first skin material is located on the outer side and the second surface covered with the second skin material is located on the inner side. The slanting surfaces at the opposite side edge portions are then brought into surface contact with each other so that the first skin material and the second skin material overlap with each other, and the flat surfaces are caused to butt against each other, whereby a tubular body for pipe is obtained. Then, the tubular body for pipe is heated to a predetermined temperature. As a result, the slanting surfaces of the tubular body are brazed together, and the flat surfaces of the tubular body are brazed together, whereby the pipe is completed.

However, when the pipes of the header tanks are manufactured from the clad material disclosed in the above-mentioned publication by the above-described method, the spontaneous potential of a eutectic brazing material formed between the first slanting surface and the second slanting surface after the brazing becomes lower than the spontaneous potential of the core material. Therefore, the eutectic brazing material is preferentially corroded, which raises a problem in that the corrosion resistance of the brazed portion is low. In particular, in an acidic environment, since the dissolving speed of the eutectic brazing material becomes high, the preferential corrosion of the brazed portions of the pipes of the header tanks becomes remarkable. In order to prevent the preferential corrosion of the brazed portions of the pipes, painting or chemical conversion treatment such as chromate treatment must be performed. Work for performing painting or chemical conversion treatment is troublesome and increases cost.

In order to solve such a problem, the present applicant has proposed an improved clad material (see Japanese Patent Application Laid-Open (kokai) No. 2015-9244). The improved clad material is composed of a core material, a first skin material covering one side of the core material, and a second skin material covering the other side of the core material, the clad material being brazed in a state in which the first skin material and the second skin material overlap each other. The core material is made of an Al alloy containing Mn in an amount of 0.6 to 1.5 mass %, Ti in an amount of 0.05 to 0.25 mass %, Cu in an amount less than 0.05 mass %, Zn in an amount less than 0.05 mass %, Fe in an amount of 0.2 mass % or less, and Si in an amount of 0.45 mass % or less, the balance being Al and unavoidable impurities. The first skin material is made of an Al alloy containing Si in an amount of 6.8 to 11.0 mass % and Zn in an amount of 0.05 mass % or less, the balance being Al and unavoidable impurities, and serves as a brazing material. The second skin material is made of an Al alloy containing Si in an amount of 4.0 to 6.0 mass % and Cu in an amount of 0.5 to 1.0 mass %, the balance being Al and unavoidable impurities. The above-mentioned publication also discloses a method of manufacturing a brazed pipe by forming the above-described clad material into a tubular shape such that the first surface covered with the first skin material is located on the outer side and the second surface covered with the second skin material is located on the inner side, mating opposite side edge portions of the clad material with each other such that the first skin material and the second skin material overlap each other, and brazing together the opposite side edge portions of the clad material by making use of the first skin material of the clad material. The above-mentioned publication further discloses a brazed pipe manufactured by the above-described method, wherein the eutectic brazing material present between the brazed opposite side edge portions of the clad material is higher in spontaneous potential than the core material.

In the case of a pipe manufactured by the above-described method through use of the clad material disclosed in Japanese Patent Application Laid-Open No. 2015-9244, the spontaneous potential of the eutectic brazing material formed between the first slanting surface and the second slanting surface after brazing becomes higher than and noble with respect to the spontaneous potential of the core material. Therefore, the eutectic brazing material is prevented from being corroded preferentially over the core material, whereby the corrosion resistance of the joined portion is improved.

Incidentally, in the case where the pipe of each header tank has a cylindrical shape and has a relatively large diameter, it becomes difficult to manufacture the pipe by the above-described method.

A conceivable pipe manufacturing method which overcomes the above-mentioned difficulty is as follows. The clad material disclosed in Japanese Patent Application Laid-Open No. 2015-9244 is formed into a tubular shape such that the first surface covered with the first skin material is located on the outer side and the second surface covered with the second skin material is located on the inner side, and opposite side edge portions of the clad material are welded together by means of high frequency resistance welding in a state in which the opposite side edge portions of the clad material butt against each other as a result of application of pressure between the opposite side edge portions. However, the pipes manufactured by such a method have a problem in that when a joint portion formed as a result of the welding (hereinafter referred to as a “welded joint portion) has a flaw, corrosion of the welded joint portion progresses remarkably.

### SUMMARY OF THE INVENTION

An object of the present invention is to solve the above-described problem and to provide a clad material which is suitable for manufacture of a pipe in which the clad material is formed into a tubular shape, and opposite side edge portions of the clad material are welded together by means of high frequency resistance welding in a state in which the opposite side edge portions butt against each other as a result of application of pressure between the opposite side edge portions. Another object of the present invention is to provide a method of manufacturing a pipe from the clad member. Still another object of the present invention is to provide the pipe and a heat exchanger which includes the pipe.

A clad material according to the present invention comprises a core material, a first skin material covering one side of the core material, and a second skin material covering the other side of the core material, the clad material having opposite side edge portions to be joined by means of high frequency resistance welding in a state in which the opposite side edge portions are caused to butt against each other such that a portion of the first skin material located at one of the side edge portions and a portion of the first skin material located at the other side edge portion face the same side and a portion of the second skin material located at the one side edge portion and a portion of the second skin material located at the other side edge portion face the same side. The clad material further comprises an intermediate material interposed between the core material and the first skin material. The core material is made of an Al alloy containing Cu in an amount of 0.3 to 0.5 mass %, Mn in an amount of 0.6 to 1.0 mass %, Ti in an amount of 0.05 to 0.15 mass %, Zn in an amount of 0.1 mass % or less, Fe in an amount of 0.3 mass % or less, and Si in an amount of 0.2 mass % or less, the balance being Al and unavoidable impurities. The first skin material is made of an Al alloy containing Si in an amount of 7.9 to 9.5 mass %, Fe in an amount of 0.1 to 0.3 mass %, and Cu in an amount of 0.3 mass % or less, the balance being Al and unavoidable impurities. The second skin material is made of an Al alloy containing Si in an amount of 4.5 to 5.5 mass %, Cu in an amount of 0.5 to 0.7 mass %, and Fe in an amount of 0.8 mass % or less, the balance being Al and unavoidable impurities. The intermediate material is made of an Al alloy containing Mn in an amount of 0.2 to 0.4 mass %, Zn in an amount of 0.2 to 0.4 mass %, Fe in an amount of 0.4 mass % or less, and Cu in an amount of 0.05 mass % or less, the balance being Al and unavoidable impurities.

A pipe manufacturing method according to the present invention comprises: forming the clad material according to the present invention into a tubular shape such that a first surface of the clad material covered with the first skin material is located on an outer side and a second surface of the clad material covered with the second skin material is located on an inner side; and welding the opposite side edge portions of the clad material together by means of high frequency resistance welding in a state in which the opposite side edge portions of the clad material butt against each other as a result of application of pressure between the opposite side edge portions.

A pipe according to the present invention is a pipe manufactured by the method according to the present invention. The pipe is composed of the core material, the first skin material covering an outer circumferential surface of the core material, the second skin material covering an inner circumferential surface of the core material, and the intermediate material interposed between the core material and the first skin material, wherein the core material is exposed on outer and inner circumferential surfaces of the pipe at a welded joint portion formed as a result of welding between the oppose side edge portions of the clad material and in the vicinity of the welded joint portion.

A heat exchanger according to the present invention comprises a plurality of heat exchange tubes formed of a bare material and disposed such that they have the same longitudinal direction and are spaced from one another; fins each formed of a brazing sheet and disposed between adjacent heat exchange tubes; and a plurality of header tanks disposed on opposite sides of the heat exchange tubes with respect to the longitudinal direction of the heat exchange tubes such that the longitudinal direction of the header tanks coincides with a direction in which the heat exchange tubes are juxtaposed, wherein at least one of the header tanks is composed of the pipe according to claim 3, and closing members which close openings of the pipe at opposite ends thereof; the pipe has a plurality of tube insertion holes formed in a region located away from the welded joint portion of the pipe; the heat exchange tubes are inserted into the tube insertion holes and brazed to the pipe through use of the first and second skin materials; and a heat exchanger component is disposed on the pipe at a position located away from the welded joint portion and brazed to the pipe through use of the first skin material.

### BRIEF DESCRIPTION OF THE DRAWINGS

FIG. 1 is an enlarged cross-sectional view showing a portion of a clad material according to the present invention;

FIG. 2 is a detailed front view showing the overall structure of a condenser in which pipes formed of the clad material of FIG. 1 are used for header tanks;

FIG. 3 is a schematic front view of the condenser of FIG. 2;

FIG. 4 is an enlarged cross-sectional view of the condenser taken along line A-A of FIG. 2; and

FIG. 5 is an enlarged view of a portion of FIG. 4.

### DESCRIPTION OF THE PREFERRED EMBODIMENT

An embodiment of the clad material according to the present invention will next be described.

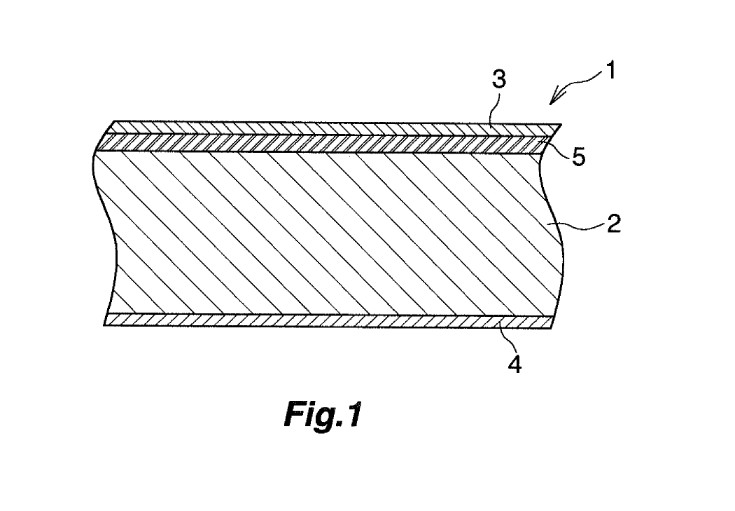

Herein, the upper side, lower side, left-hand side, and right-hand side of FIG. 1 will be referred to as “upper,” “lower,” “left,” and “right,” respectively.

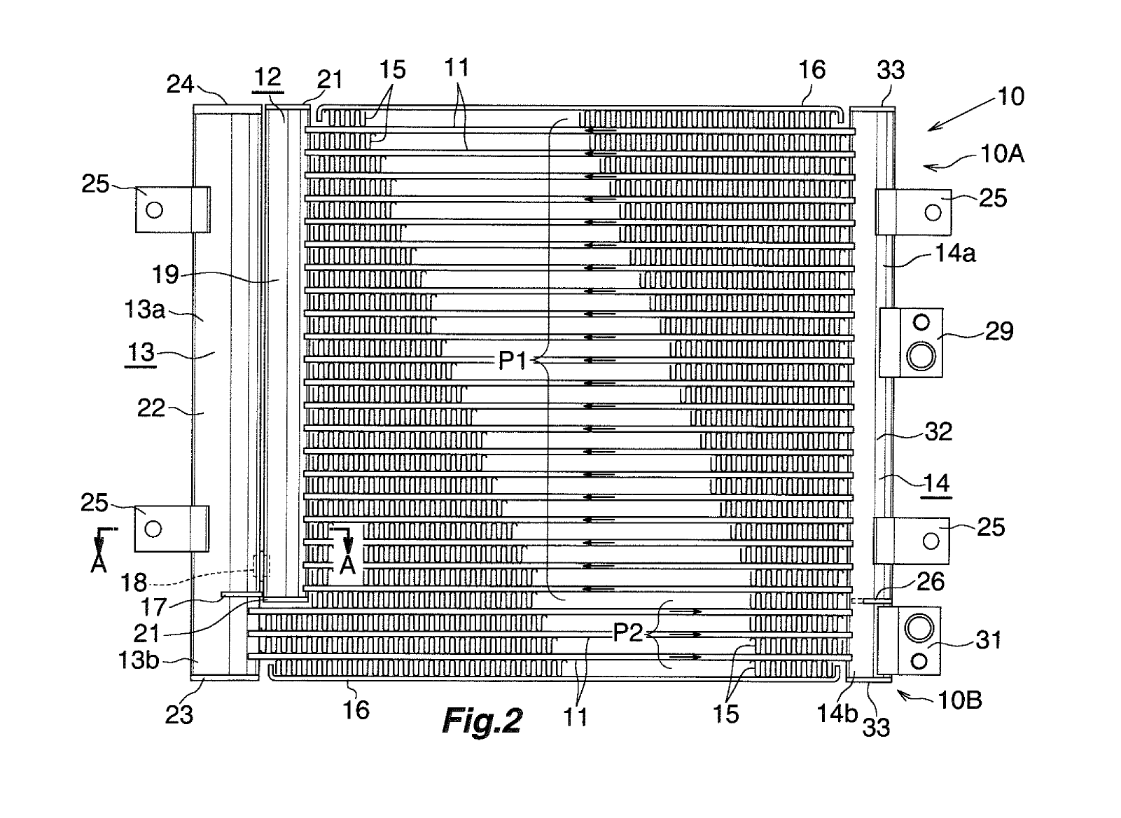

FIG. 1 shows the clad material of the present invention, and FIGS. 2 through 5 show a condenser in which pipes formed of the clad material of FIG. 1 are used for header tanks.

As shown in FIG. 1, the clad material 1 is composed of a core material 2, a first skin material 3 covering one side of the core material 2, a second skin material 4 covering the other side of the core material 2, and an intermediate material 5 interposed between the core material 2 and the first skin material 3.

The core material 2 is made of an Al alloy containing Cu in an amount of 0.3 to 0.5 mass %, Mn in an amount of 0.6 to 1.0 mass %, Ti in an amount of 0.05 to 0.15 mass %, Zn in an amount of 0.1 mass % or less, Fe in an amount of 0.3 mass % or less, and Si in an amount of 0.2 mass % or less, the balance being Al and unavoidable impurities. Notably, the core material 2 may contain Cr as an unavoidable impurity in an amount of 0.05 mass % or less.

The first skin material 3 is made of an Al alloy containing Si in an amount of 7.9 to 9.5 mass %, Fe in an amount of 0.1 to 0.3 mass %, and Cu in an amount of 0.3 mass % or less, the balance being Al and unavoidable impurities. Notably, the first skin material 3 may contain, as unavoidable impurities, Mn in an amount of 0.05 mass % or less, Zn in an amount of 0.05 mass % or less, Cr in an amount of 0.05 mass % or less, and Ti in an amount of 0.05 mass % or less.

The second skin material 4 is made of an Al alloy containing Si in an amount of 4.5 to 5.5 mass %, Cu in an amount of 0.5 to 0.7 mass %, and Fe in an amount of 0.8 mass % or less, the balance being Al and unavoidable impurities. Notably, the second skin material 4 may contain, as unavoidable impurities, Mn in an amount of 0.05 mass % or less, Zn in an amount of 0.05 mass % or less, Cr in an amount of 0.05 mass % or less, and Ti in an amount of 0.05 mass % or less.

The intermediate material 5 is made of an Al alloy containing Mn in an amount of 0.2 to 0.4 mass %, Zn in an amount of 0.2 to 0.4 mass %, Fe in an amount of 0.4 mass % or less, and Cu in an amount of 0.05 mass % or less, the balance being Al and unavoidable impurities. Notably, the intermediate material 5 may contain, as unavoidable impurities, Si in an amount of 0.25 mass % or less, Cr in an amount of 0.05 mass % or less, and Ti in an amount of 0.05 mass % or less.

The alloy compositions of the core material 2, the first skin material 3, the second skin material 4, and the intermediate material 5 of the clad material 1 will now be described.

### [Core Material 2]

Cu makes the spontaneous potential of the core material 2 noble to thereby improve the corrosion resistance of the core material 2. When the Cu content is excessively low, the core material 2 cannot have sufficiently high corrosion resistance, and pitting corrosion may occur. When the Cu content is excessively high, the strength of the core material 2 becomes excessively high, and a formation defect may occur when the clad material 1 is formed into a tubular shape. Accordingly, the Cu content must be 0.3 to 0.5 mass %.

Mn increases the strength of the core material 2 to thereby increase the withstanding pressure of header tanks manufactured through use of the clad material 1. When the Mn content is excessively low, a sufficient degree of strength cannot be attained. When the Mn content is excessively high, the strength of the core material 2 becomes excessively high, and a formation defect may occur when the clad material 1 is formed into a tubular shape. Accordingly, the Mn content must be 0.6 to 1.0 mass %.

Ti forms a Ti-Al compound in the Al alloy and disperses in layers. Since the spontaneous potential of the Ti-Al compound is noble, corrosion occurs in layers, and corrosion in the thickness direction (pitting corrosion) becomes unlikely to occur. Therefore, Ti improves the corrosion resistance. When the Ti content is excessively low, its effect of causing corrosion to occur in layers diminishes, and corrosion resistance lowers. When the Ti content is excessively high, its effect of improving the corrosion resistance saturates, and cost increases. Accordingly, the Ti content must be 0.05 to 0.15 mass %.

Zn, Fe, and Si are contained in the core material 2 as unavoidable impurities. When their contents are excessively high, the corrosion resistance of the core material 2 itself decreases. Therefore, their contents must be the above-mentioned contents.

Notably, the amounts of Zn, Fe, and Si contained as unavoidable impurities may be zero in some cases.

### [First Skin Material 3]

The first skin material 3 is a typical Al alloy brazing filler, and the Si content of the first skin material 3 is 7.9 to 9.5 mass %.

Fe improves the fluidity of the first skin material 3 in a melted state. When the Fe content is excessively low, a sufficient degree of brazing material flowability cannot be obtained. When the Fe content is excessively high, corrosion resistance lowers. Accordingly, the Fe content must be 0.1 to 0.3 mass %.

Cu is contained in the first skin material 3 as an unavoidable impurity. When the Cu content is excessively high, corrosion of the intermediate material 5 is accelerated. Therefore, the Cu content must be the above-mentioned content.

Notably, the amount of Cu contained as an unavoidable impurity may be zero in some cases.

### [Second Skin Material 4]

The second skin material 4 serves as a brazing material. As in the case of an ordinary Al alloy brazing filler, Si affects the flowability of the second skin material 4 in a melted state. When the Si content is excessively low, the second skin material 4 in a melted state does not have a sufficient degree of flowability. Therefore, in the case where the clad material 1 is used for the header tanks, a brazing failure may occur when the header tanks and heat exchange tubes are brazed together. When the Si content is excessively high, the second skin material 4 in a melted state has an excessive degree of flowability. Therefore, in the case where the clad material 1 is used for the header tanks, the second skin material 4 may flow into the channels of heat exchange tubes which are brazed to the header tanks. Therefore, the Si content must be 4.5 to 5.5 mass %.

In the case where the clad material 1 used for the header tanks, Cu suppresses the progress of corrosion of portions of the header tanks, which portions are brazed to heat exchange tubes. When the Cu content is excessively low, the progress of corrosion of the brazed portions cannot be suppressed to a sufficient degree. When the Cu content is excessively high, the second skin material 4 cracks when it solidifies during casting. Accordingly, the Cu content must be 0.5 to 0.7 mass %.

Fe is contained in the second skin material 4 as an unavoidable impurity. When the Fe content is excessively high, a problem occurs in that when the clad material 1 is used for the header tanks, the corrosion resistance of portions of the header tanks, which portions are brazed to heat exchange tubes lowers. Therefore, the Fe content must be the above-mentioned content.

Notably, the amount of Fe contained as an unavoidable impurity may be zero in some cases.

### [Intermediate Material 5]

Mn increases the strength of the intermediate material 5 to thereby make it possible to properly pressure-bond the intermediate material 5 and the core material 2 together and the intermediate material 5 and the first skin material 3 together at the time of rolling. When the Mn content is excessively low, it is impossible to properly pressure-bond the intermediate material 5 and the core material 2 together and the intermediate material 5 and the first skin material 3 together at the time of rolling. When the Mn content is excessively high, the strength of the intermediate material 5 becomes excessively high, and a failure of pressure-bonding occurs between the intermediate material 5 and the core material 2 or between the intermediate material 5 and the first skin material 3 at the time of rolling. Accordingly, the Mn content must be 0.2 to 0.4 mass %.

Zn adjusts the progress speed of corrosion of the intermediate material 5. When the Zn content is excessively low, the potential difference between the intermediate material 5 and the core material 2 becomes insufficient, and corrosion occurs in the core material 2. When the Zn content is excessively high, the progress speed of corrosion of the intermediate material 5 becomes excessively high, and the intermediate material 5 is consumed within a relatively short period of time. Accordingly, the Zn content must be 0.2 to 0.4 mass %.

Fe is contained in the intermediate material 5 as an unavoidable impurity. When the Fe content is excessively high, the corrosion resistance of the intermediate material 5 lowers. Therefore, the Fe content must be the above-mentioned content.

Cu is contained in the intermediate material 5 as an unavoidable impurity. When the Cu content is excessively high, the potential difference between the intermediate material 5 and the core material 2 becomes insufficient, and corrosion occurs in the core material 2. Therefore, the Cu content must be the above-mentioned content.

Notably, the amounts of Fe and Cu contained as unavoidable impurities may be zero in some cases.

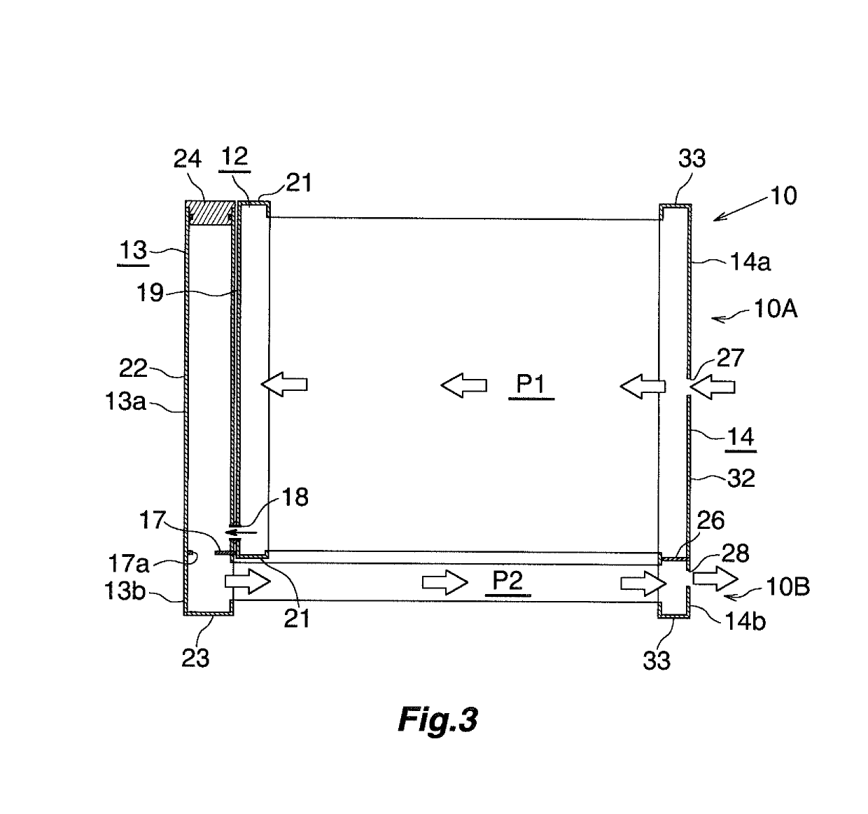

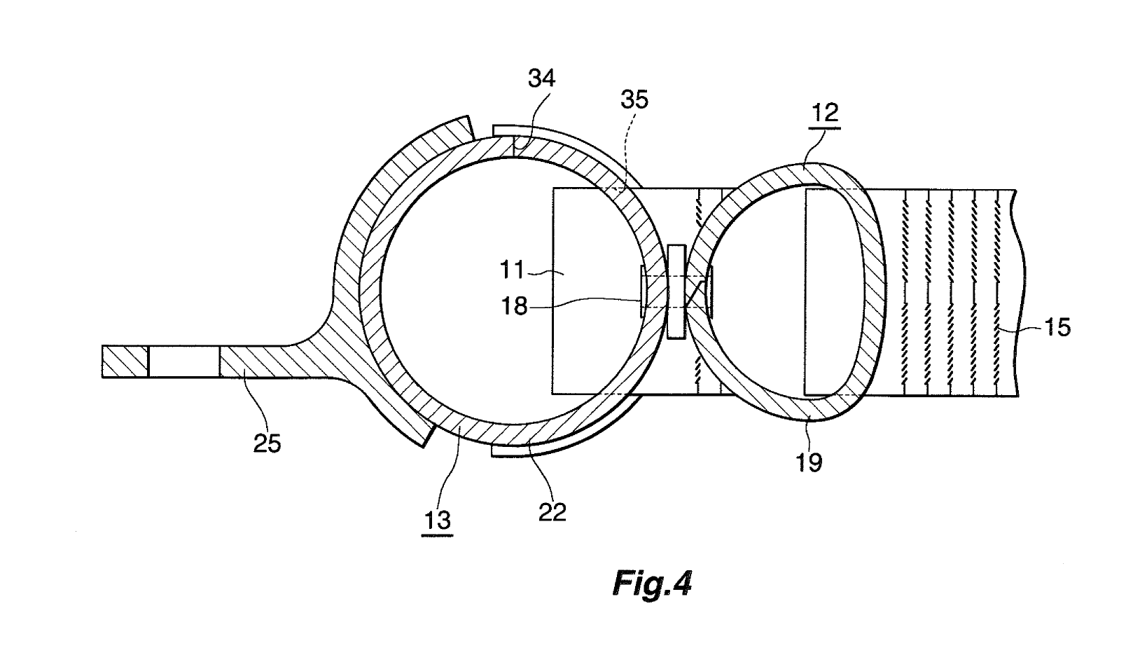

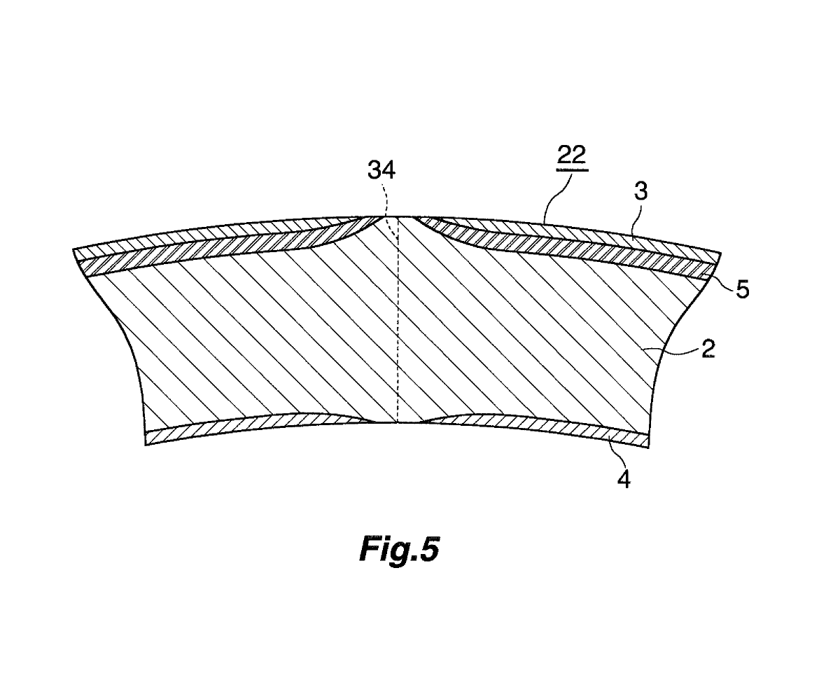

FIGS. 2 and 3 show the overall structure of a condenser in which pipes formed of the clad material 1 are used for header tanks, and FIGS. 4 and 5 show the structure of a main portion of the condenser.

In FIGS. 2 through 4, a condenser 10 has a condensation section 10A and a super-cooling section 10B provided below the condensation section 10A. The condenser 10 includes a plurality of flat heat exchange tubes 11 formed of aluminum extrudate, three header tanks 12, 13, 14 formed of aluminum, corrugated fins 15 formed of aluminum, and side plates 16 formed of aluminum. The heat exchange tubes 11 are disposed at predetermined intervals in the vertical direction such that their width direction coincides with an air-passing direction (a direction perpendicular to the sheets on which FIG. 2 and FIG. 3 are drawn) and their longitudinal direction coincides with the left-right direction. The header tanks 12, 13, 14 are disposed such that their longitudinal direction coincides with the vertical direction, and left and right end portions of the heat exchange tubes 11 are brazed to the header tanks 12, 13, 14. Each of the corrugated fins 15 is disposed between and brazed to adjacent heat exchange tubes 11, or is disposed on the outer side of the uppermost or lowermost heat exchange tube 11 and brazed to the corresponding heat exchange tube 11. The side plates 16 are disposed on the corresponding outer sides of the uppermost and lowermost corrugated fins 15, and are brazed to these corrugated fins 15.

Each of the condensation section 10A and super-cooling section 10B of the condenser 10 includes at least one (only one in the present embodiment) heat exchange path P1, P2 formed by a plurality of heat exchange tubes 11 successively arranged in the vertical direction. The heat exchange path P1 provided in the condensation section 10A serves as a refrigerant condensation path. The heat exchange path P2 provided in the super-cooling section 10B serves as a refrigerant super-cooling path. The flow direction of refrigerant is the same among all the heat exchange tubes 11 which form the respective heat exchange paths P1, P2. The flow direction of refrigerant in the heat exchange tubes 11 which form a certain heat exchange path is opposite the flow direction of refrigerant in the heat exchange tubes 11 which form another heat exchange path adjacent to the certain heat exchange path. The heat exchange path P1 of the condensation section 10A will be referred to as the first heat exchange path, and the heat exchange path P2 of the super-cooling section 10B will be referred to as the second heat exchange path.

The first header tank 12 and the second header tank 13 are individually provided at the left end of the condenser 10 in such a manner that the second header tank 13 is located on the outer side of the first header tank 12 in the left-right direction. Left end portions of all the heat exchange tubes 11 which form the first heat exchange path P1 provided in the condensation section 10A are connected to the first header tank 12 by brazing. Left end portions of all the heat exchange tubes 11 which form the second heat exchange path P2 provided in the super-cooling section 10B are connected to the second header tank 13 by brazing. The lower end of the second header tank 13 is located below the lower end of the first header tank 12, and the upper end of the second header tank 13 is located above the lower end of the first header tank 12. All the heat exchange tubes 11 of the second heat exchange path P2 are connected to a portion of the second header tank 13 located below the lower end of the first header tank 12. Namely, the second header tank 13 is divided into an upper section 13a and a lower section 13b by a plate-shaped partition member 17 formed of aluminum and provided at a height between the first heat exchange path P1 and the second heat exchange path P2. Left end portions of all the heat exchange tubes 11 which form the second heat exchange path P2 provided in the super-cooling section 10B are connected to the lower section 13b by brazing. The upper section 13a and the lower section 13b communicate with each other through a communication opening 17a formed in the partition member 17. The second header tank 13 has a function of storing the refrigerant flowing from the condensation section 10A, separating it into gaseous and liquid phases, and supplying liquid phase predominant refrigerant to the super-cooling section 10B. Although not shown in the drawings, a desiccant is disposed in the upper section 13a of the second header tank 13.

A communication member 18 made of aluminum and brazed to the first and second header tanks 12 and 13 establishes communication between a portion of the interior of the first header tank 12 near the lower end thereof and a portion of the interior of the upper section 13a of the second header tank 13 near the lower end thereof.

The first header tank 12 is composed of an aluminum pipe 19 which has openings at upper and lower ends thereof and has a non-circular transverse cross section, and aluminum closing members 21 brazed to the upper and lower ends of the pipe 19 so as to close the openings at the upper and lower ends.

The second header tank 13 is composed of an aluminum pipe 22 which has openings at upper and lower ends thereof and has a circular transverse cross section, a member 23 brazed to the lower end of the pipe 22 so as to close the opening at the lower end, and an upper closing member 24 detachably attached to the upper end of the pipe 22 so as to close the opening at the upper end. Two aluminum brackets 25, which are heat exchanger components, are brazed to the pipe 22 of the second header tank 13 such that they are spaced from each other in the vertical direction.

The third header tank 14 is disposed at the right end of the condenser 10, and right end portions of all the heat exchange tubes 11 which form the first and second heat exchange paths P1 and P2 are connected to the third header tank 14. The third header tank 14 is divided into an upper section 14a and a lower section 14b by a plate-shaped partition member 26 formed of aluminum and provided at a height between the first heat exchange path P1 and the second heat exchange path P2. Right end portions of all the heat exchange tubes 11 which form the first heat exchange path P1 provided in the condensation section 10A are connected to the upper section 14a by brazing, and right end portions of all the heat exchange tubes 11 which form the second heat exchange path P2 provided in the super-cooling section 103 are connected to the lower section 14b by brazing. Also, the upper section 14a of the third header thank 14 has a refrigerant inlet 27 formed at the center of the upper section 14a in the height direction thereof, and the lower section 14b of the third header thank 14 has a refrigerant outlet 28. Also, an aluminum refrigerant inlet member 29 communicating with the refrigerant inlet 27 and an aluminum refrigerant outlet member 31 communicating with the refrigerant outlet 28 are brazed to the third header tank 14. Two aluminum brackets 25 are also brazed to the third header tank 14 such that they are spaced from each other in the vertical direction.

The third header tank 13 is composed of an aluminum pipe 32 which has openings at upper and lower ends thereof and has the same transverse cross-sectional shape as that of the first header tank 12, and aluminum closing members 33 brazed to the upper and lower ends of the pipe 32 so as to close the openings at the upper and lower ends.

In the condenser 10, refrigerant flows into the upper section 14a of the third header tank 14 through the refrigerant inlet member 29 and the refrigerant inlet 27. The refrigerant flows through the first heat exchange path P1, the first header tank 12, the communication member 18, the upper section 13a of the second header tank 13, the communication opening 17a, the lower section 13b of the second header tank 13, the second heat exchange path P2, and the lower section 14b of the third header tank 14, and then flows out through the refrigerant outlet 28 and the refrigerant outlet member 31.

The pipe 22 of the second header tank 13 of the condenser 10 is formed through use of the clad material 1. As shown in FIGS. 4 and 5, the pipe 22 is formed by bending the clad material 1 into a cylindrical tubular shape such that the first skin material 3 is located on the outer surface side, and opposite side edge portions of the clad material 1 are welded together by means of high frequency resistance welding in a state in which the opposite side edge portions butt against each other as a result of application of pressure between the opposite side edge portions. The pipe 22 is composed of the core material 2, the first skin material 3 covering the outer circumferential surface of the core material 2, the second skin material 4 covering the inner circumferential surface of the core material 2, and the intermediate material 5 interposed between the core material 2 and the first skin material 3. At a welded joint portion 34 formed as a result of welding between the oppose side edge portions of the clad material 1 of the pipe 22 and in the vicinity thereof, the core material 2 is exposed on the outer and inner circumferential surfaces of the pipe 22. The outer circumferential surface of the pipe 22, excluding a portion where the core material 2 is exposed, is covered with the first skin material 3, and the inner circumferential surface of the pipe 22, excluding a portion where the core material 2 is exposed, is covered with the second skin material 4. The welded joint portion 34 of the pipe 22 is located on the downstream side with respect to the air-passing direction (on the upper side of FIG. 4).

A plurality of tube insertion holes 35 elongated in the air-passing direction are formed in a right side portion of the pipe 22 at predetermined intervals in the vertical direction such that the tube insertion holes 35 are spaced from the welded joint portion 34. The heat exchange tubes 11 are inserted into the tube insertion holes 33 and are brazed to the pipe 22 through use of the first skin material 3 and the second skin material 4 of the clad material 1. The brackets 25 are brazed to a left side portion of the pipe 22 spaced from the welded joint portion 34 through use of the first skin material 3.

Notably, the pipes 19 and 32 of the first header tank 12 and the third header tank 14 are manufactured by, for example, the method described in Japanese Patent Application Laid-Open No. 2015-9244. Specifically, there is prepared a clad material which is composed of a core material, a first skin material covering one side of the core material, and a second skin material covering the other side of the core material. The core material is made of an Al alloy containing Mn in an amount of 0.6 to 1.5 mass %, Ti in an amount of 0.05 to 0.25 mass %, Cu in an amount less than 0.05 mass %, Zn in an amount less than 0.05 mass %, Fe in an amount of 0.2 mass % or less, and Si in an amount of 0.45 mass % or less, the balance being Al and unavoidable impurities. The first skin material is made of an Al alloy containing Si in an amount of 6.8 to 11.0 mass % and Zn in an amount of 0.05 mass % or less, the balance being Al and unavoidable impurities. The second skin material is made of an Al alloy containing Si in an amount of 4.0 to 6.0 mass % and Cu in an amount of 0.5 to 1.0 mass %, the balance being Al and unavoidable impurities. The clad material is bent into a tubular shape such that the first surface covered with the first skin material is located on the outer side and the second surface covered with the second skin material is located on the inner side. Subsequently, opposite side edge portions of the clad material are mated with each other such that the first skin material and the second skin material overlap each other, and the opposite side edge portions of the clad material are brazed together by making use of the first skin material of the clad material. Notably, manufacture of the pipes 19 and 32 is performed simultaneously with brazing of other components of the condenser 10.

The condenser 10 using the above-described pipe 22 is manufactured by combining the heat exchange tubes 11, the clad material formed into a tubular shape for the pipe 19 of the first header tank 12, the upper and lower closing members 21, the pipe 22 constituting the second header tank 13, the lower closing member 23, the partition member 17, the clad material formed into a tubular shape for the pipe 32 of the third header tank 14, the upper and lower closing members 33, the partition wall 26, the communication member 18, the corrugated fins 15, and the side plates 16; and brazing these components together.

Next, a specific example of the present invention will be described.

A clad material 1 shown in Table 1 was prepared. The thickness of the clad material 1 is 1.6 mm, the cladding ratios of the first skin material 3 and the second skin material 4 are 6%, and the cladding ratio of the intermediate material 5 is 10%.

TABLE 1

Alloy composition (mass %)

| | Si | Fe | Cu | Mn | Zn | Ti | Al |
|---|---|---|---|---|---|---|---|
| First skin | 8.7 | 0.2 | 0.2 | — | — | — | Balance |
| material | | | | | | | |
| Intermediate | — | 0.2 | — | 0.2 | 0.3 | — | Balance |
| material | | | | | | | |
| Core | — | 0.2 | 0.4 | 0.8 | — | 0.1 | Balance |
| material | | | | | | | |
| Second skin | 5.0 | 0.4 | 0.6 | — | — | — | Balance |
| material | | | | | | | |

Subsequently, the pipe 22 was made by bending the clad material 1 of Table 1 into a tubular shape such that the first skin material 3 was located on the outer surface side and welding opposite side edge portions of the clad material together by means of high frequency resistance welding in a state in which the opposite side edge portions butt against each other as a result of application of pressure between the opposite side edge portions.

Subsequently, the pipe 22 was combined with other components, noncorrosive fluoride-based flux was applied to the resultant assembly, and the assembly was heated in a furnace filled with nitrogen gas such that the actual temperature became 598.0 to 603.6° C., whereby the condenser 10 having the above-described structure was manufactured. The heating rate is 35 to 50° C/min for a temperature range of 100 to 500° C., 14.7 to 18.7° C/rain for a temperature range of 500 to 580° C., and 3.7 to 5.5° C/min for a temperature range of 580 to 600° C. The period of time during which the assembly is maintained at 58° C. or higher is 4.0 to 6.8 min.

An ASTM-SWAAT test was performed on the condenser 10 manufactured as described above for 40 days. No leakage occurred even after elapse of the test period. Further, the cross section of the circumferential wall of the second header tank 13 was observed to determine the progress of corrosion. No corrosion occurred in the core material 2 including the welded joint portion 34 and the vicinity thereof.

The present invention comprises the following modes.

1) A clad material comprising a core material, a first skin material covering one side of the core material, and a second skin material covering the other side of the core material, the clad material having opposite side edge portions to be joined by means of high frequency resistance welding in a state in which the opposite side edge portions are caused to butt against each other such that a portion of the first skin material located at one of the side edge portions and a portion of the first skin material located at the other side edge portion face the same side and a portion of the second skin material located at the one side edge portion and a portion of the second skin material located at the other side edge portion face the same side,

the clad material further comprising an intermediate material interposed between the core material and the first skin material, wherein

the core material is made of an Al alloy containing Cu in an amount of 0.3 to 0.5 mass %, Mn in an amount of 0.6 to 1.0 mass %, Ti in an amount of 0.05 to 0.15 mass %, Zn in an amount of 0.1 mass % or less, Fe in an amount of 0.3 mass % or less, and Si in an amount of 0.2 mass % or less, the balance being Al and unavoidable impurities;

the first skin material is made of an Al alloy containing Si in an amount of 7.9 to 9.5 mass %, Fe in an amount of 0.1 to 0.3 mass %, and Cu in an amount of 0.3 mass % or less, the balance being Al and unavoidable impurities;

the second skin material is made of an Al alloy containing Si in an amount of 4.5 to 5.5 mass %, Cu in an amount of 0.5 to 0.7 mass %, and Fe in an amount of 0.8 mass % or less, the balance being Al and unavoidable impurities; and

the intermediate material is made of an Al alloy containing Mn in an amount of 0.2 to 0.4 mass %, Zn in an amount of 0.2 to 0.4 mass %, Fe in an amount of 0.4 mass % or less, and Cu in an amount of 0.05 mass % or less, the balance being Al and unavoidable impurities.

2) A method of manufacturing a pipe, comprising: forming the clad material according to par. 1) into a tubular shape such that a first surface of the clad material covered with the first skin material is located on an outer side and a second surface of the clad material covered with the second skin material is located on an inner side; and welding the opposite side edge portions of the clad material together by means of high frequency resistance welding in a state in which the opposite side edge portions of the clad material butt against each other as a result of application of pressure between the opposite side edge portions.

3) A pipe manufactured by the method of par. 2) which is composed of the core material, the first skin material covering an outer circumferential surface of the core material, the second skin material covering an inner circumferential surface of the core material, and the intermediate material interposed between the core material and the first skin material, wherein the core material is exposed on outer and inner circumferential surfaces of the pipe at a welded joint portion formed as a result of welding between the oppose side edge portions of the clad material and in the vicinity of the welded joint portion.

4) A heat exchanger comprising a plurality of heat exchange tubes formed of a bare material and disposed such that they have the same longitudinal direction and are spaced from one another; fins each formed of a brazing sheet and disposed between adjacent heat exchange tubes; and a plurality of header tanks disposed on opposite sides of the heat exchange tubes with respect to the longitudinal direction of the heat exchange tubes such that the longitudinal direction of the header tanks coincides with a direction in which the heat exchange tubes are juxtaposed, opposite end portions of the heat exchange tubes being connected to the header tanks, wherein at least one of the header tanks is composed of the pipe according to par. 3), and closing members which close openings of the pipe at opposite ends thereof; the pipe has a plurality of tube insertion holes formed in a region located away from the welded joint portion of the pipe; the heat exchange tubes are inserted into the tube insertion holes and brazed to the pipe through use of the first and second skin materials; and a heat exchanger component is disposed on the pipe at a position located away from the welded joint portion and brazed to the pipe through use of the first skin material.

The clad material of par. 1) has the following advantageous effects. In the case of a pipe manufactured by the method of forming the clad material into a tubular shape such that a first surface of the clad material covered with the first skin material is located on the outer side and a second surface of the clad material covered with the second skin material is located on the inner side and welding the opposite side edge portions of the clad material together by means of high frequency resistance welding in a state in which the opposite side edge portions of the clad material butt against each other as a result of application of pressure between the opposite side edge portions, the spontaneous potential of the intermediate material becomes less noble than that of the core material so that the intermediate material is corroded preferentially over the core material. Therefore, even in the case where a welding defect is present in the welded joint portion, the progress of corrosion of the welded joint portion is suppressed. Accordingly, the corrosion resistance of the welded joint portion of the pipe is improved. In addition, chemical conversion treatment such as chromate treatment and painting become unnecessary, whereby cost can be lowered.

In the case of the pipe manufactured by the method of par. 2) and the pipe of par. 3), the effects similar to the effects described in par. 1) are obtained.

The heat exchanger of par. 4) has the following advantage effects. In the header tank having the pipe of par. 3), the spontaneous potential of the intermediate material of the pipe becomes less noble than the core material so that the intermediate material is corroded preferentially over the core material. Therefore, even in the case where a welding defect is present in the welded joint portion, the progress of corrosion of the welded joint portion is suppressed. Accordingly, the corrosion resistance of the welded joint portion of the pipe is improved. In addition, chemical conversion treatment such as chromate treatment and painting become unnecessary, whereby cost can be lowered.

What is claimed is:

1. A clad material comprising a core material, a first skin material covering one side of the core material, and a second skin material covering the other side of the core material, the clad material having opposite side edge portions to be joined by means of high frequency resistance welding in a state in which the opposite side edge portions are caused to butt against each other such that a portion of the first skin material located at one of the side edge portions and a portion of the first skin material located at the other side edge portion face the same side and a portion of the second skin material located at the one side edge portion and a portion of the second skin material located at the other side edge portion face the same side,
the clad material further comprising an intermediate material interposed between the core material and the first skin material, wherein
the core material is made of an Al alloy containing Cu in an amount of 0.3 to 0.5 mass %, Mn in an amount of 0.6 to 1.0 mass %, Ti in an amount of 0.05 to 0.15 mass %, Zn in an amount of 0.1 mass % or less, Fe in an amount of 0.3 mass % or less, and Si in an amount of 0.2 mass % or less, the balance being Al and unavoidable impurities;
the first skin material is made of an Al alloy containing Si in an amount of 7.9 to 9.5 mass %, Fe in an amount of 0.1 to 0.3 mass %, and Cu in an amount of 0.3 mass % or less, the balance being Al and unavoidable impurities;
the second skin material is made of an Al alloy containing Si in an amount of 4.5 to 5.5 mass %, Cu in an amount of 0.5 to 0.7 mass %, and Fe in an amount of 0.8 mass % or less, the balance being Al and unavoidable impurities; and
the intermediate material is made of an Al alloy containing Mn in an amount of 0.2 to 0.4 mass %, Zn in an amount of 0.2 to 0.4 mass %, Fe in an amount of 0.4 mass % or less, and Cu in an amount of 0.05 mass % or less, the balance being Al and unavoidable impurities.

2. A method of manufacturing a pipe, comprising:
forming the clad material according to claim 1 into a tubular shape such that a first surface of the clad material covered with the first skin material is located on an outer side and a second surface of the clad material covered with the second skin material is located on an inner side; and
welding the opposite side edge portions of the clad material together by means of high frequency resistance welding in a state in which the opposite side edge portions of the clad material butt against each other as a result of application of pressure between the opposite side edge portions.

3. A pipe manufactured by the method of claim 2 which is composed of the core material, the first skin material covering an outer circumferential surface of the core material, the second skin material covering an inner circumferential surface of the core material, and the intermediate material interposed between the core material and the first skin material, wherein the core material is exposed on outer and inner circumferential surfaces of the pipe at a welded joint portion formed as a result of welding between the oppose side edge portions of the clad material and in the vicinity of the welded joint portion.

4. A heat exchanger comprising:
a plurality of heat exchange tubes formed of a bare material and disposed such that they have the same longitudinal direction and are spaced from one another;
fins each formed of a brazing sheet and disposed between adjacent heat exchange tubes; and
a plurality of header tanks disposed on opposite sides of the heat exchange tubes with respect to the longitudinal direction of the heat exchange tubes such that the longitudinal direction of the header tanks coincides with a direction in which the heat exchange tubes are juxtaposed, opposite end portions of the heat exchange tubes being connected to the header tanks,
wherein at least one of the header tanks is composed of the pipe according to claim 3, and closing members which close openings of the pipe at opposite ends thereof;
the pipe has a plurality of tube insertion holes formed in a region located away from the welded joint portion of the pipe;
the heat exchange tubes are inserted into the tube insertion holes and brazed to the pipe through use of the first and second skin materials; and
a heat exchanger component is disposed on the pipe at a position located away from the welded joint portion and brazed to the pipe through use of the first skin material.
